(19) United States
(12) Patent Application Publication
(10) Pub. No.: US 2012/0152264 A1
(43) Pub. Date: Jun. 21, 2012

(54) Aerosol Generating Material for a Smoking Article

(76) Inventors: Martin Coleman, London (GB); Edward Dennis John, London (GB); Dominic Woodcock, London (GB)

(21) Appl. No.: 13/266,674

(22) PCT Filed: Apr. 28, 2010
(86) PCT No.: PCT/GB10/50690

§ 371 Date: Mar. 9, 2012

(30) Foreign Application Priority Data
Apr. 29, 2009 (GB) 0907346.1

(51) Int. Cl. A24B 13/00; C09K 3/00; B05D 7/00; A24D 1/04

(52) U.S. Cl. 131/337; 252/182.11; 252/182.29; 427/212

(57) ABSTRACT

The invention provides an aerosol generating material (6) for a smoking article, comprising particles (1) that consist essentially of diluent (2) encapsulated by barrier material (3).

The present invention relates to an aerosol generating material for a smoking article. In particular, the present invention relates to an aerosol generating material for a smoking article comprising encapsulated diluent, a method for producing the same, and products comprising the same.

It is known to include diluents in smoking articles such as cigarettes. Diluents are compounds that are vapourised during smoking and transfer to the mainstream smoke in aerosol form. They are generally selected such that they transfer to the smoke substantially intact. Other components of the smoke (tobacco-derived components in the case of tobacco-containing smoking articles, or nicotine and/or flavour components in the case of non-tobacco-containing smoking articles) are therefore “diluted” by this means.

A cigarette can comprise a filter at the mouth end, a tobacco rod comprising smokable filler material, and cigarette paper wrapped around the rod. When diluent is present in the smokable filler material, this may be as a simple mixture with the other ingredients (particularly for diluents in solid form), or the diluent may be carried on one or more of the other ingredients (particularly if the diluent is in liquid form).

WO 2007/012980 describes a tobacco-containing composition comprising added diluents, which may be administered by spraying, admixing or soaking of the tobacco.

It has been discovered that, although the diluent is vapourised during smoking in the course of performing its function, vapourisation of the diluent at lower temperatures can cause problems during storage of the cigarettes. Specifically, the diluent can migrate during storage and subsequently be lost to the atmosphere or interact with other parts of the product such as the cigarette paper. This may also lead to staining or marking of the cigarette paper, either by the diluent itself or by compounds released from the diluent interaction. Those in the art have therefore sought to immobilize the diluent until it is required.

US 2008/0110470 describes the immobilization of a diluent in a porous sorbent, which is then incorporated into a tobacco rod. However, this immobilization technique is not entirely satisfactory. For instance, the diluent loading capacity for a free-flowing sample is relatively low.

There is therefore a need in the art to incorporate diluents into smoking articles in an alternative way that overcomes one or more of the problems outlined above.

Accordingly, the present inventors have devised the invention defined in the claims.

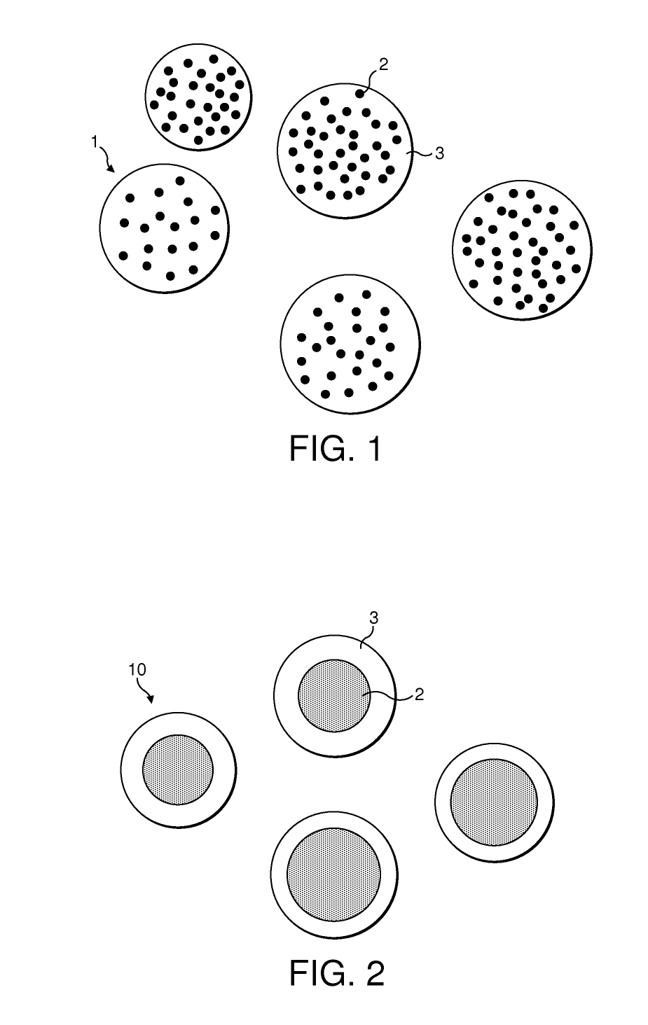

FIG. 1 shows spray-dried encapsulated diluent particles in accordance with one embodiment of the invention.

FIG. 2 shows co-extruded encapsulated diluent particles in accordance with another embodiment of the invention.

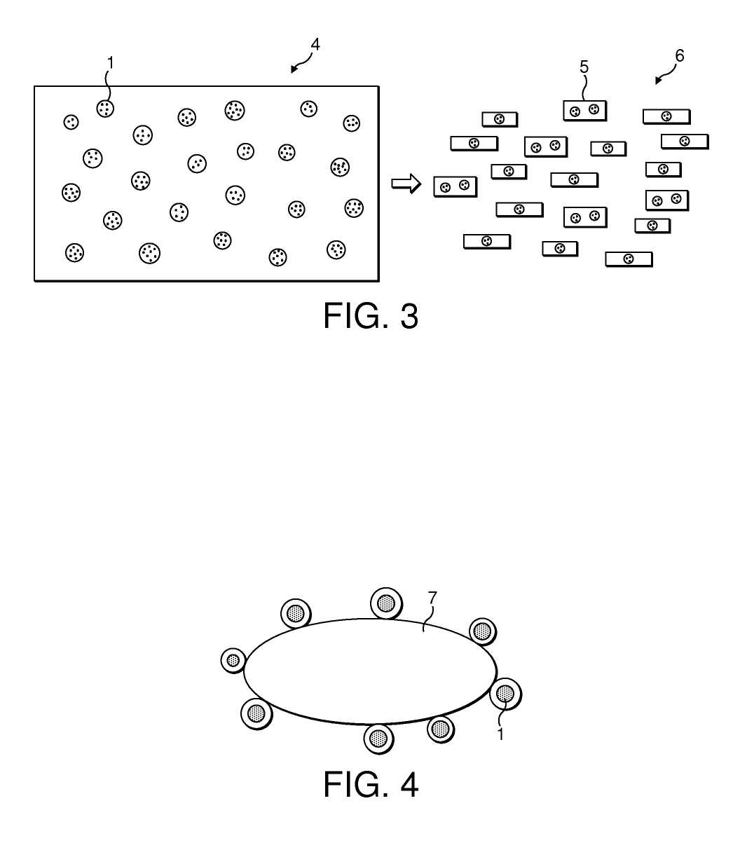

FIG. 3 shows a sheet material comprising encapsulated diluent particles, and the corresponding shredded sheet material in accordance with a further embodiment of the invention.

FIG. 4 shows encapsulated diluent particles sprayed onto tobacco in accordance with a further embodiment of the invention.

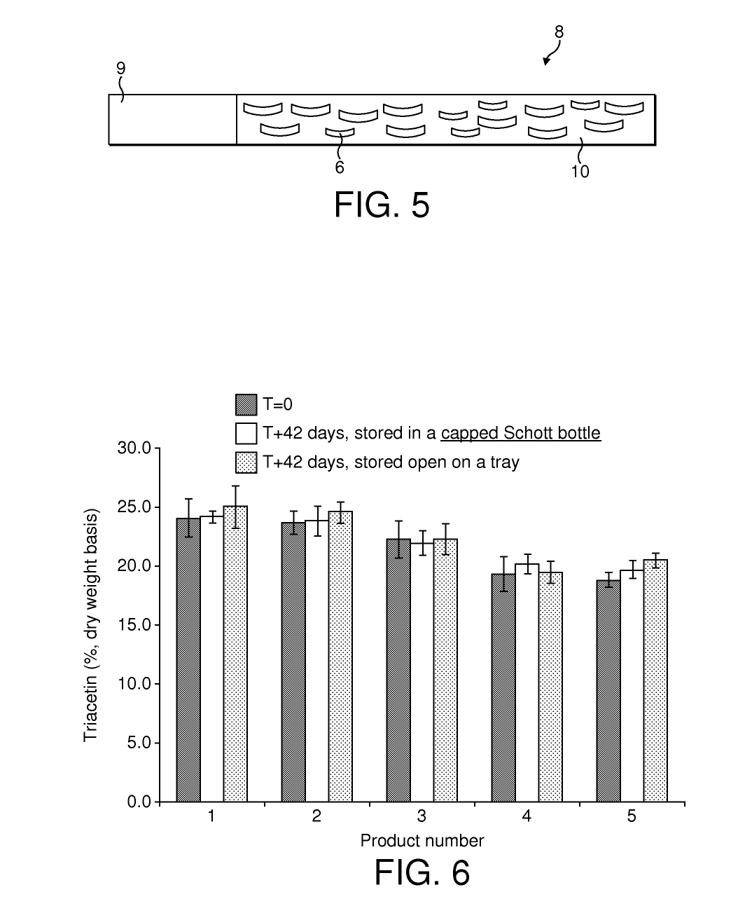

FIG. 5 shows a cigarette containing an aerosol generating material in accordance with another embodiment of the invention.

FIG. 6 shows the results of the storage trial carried out on products according to the present invention, as part of the experiments described in Example 1.

The diluent is at least one aerosol forming agent which may be, for instance, a polyol aerosol generator or a non-polyol aerosol generator, preferably a non-polyol aerosol generator. It may be a solid or liquid at room temperature, but preferably is a liquid at room temperature. Suitable polyols include sorbitol, glycerol, and glycols like propylene glycol or triethylene glycol. Suitable non-polyols include monohydric alcohols, high boiling point hydrocarbons, acids such as lactic acid, and esters such as diacetin, triacetin, triethyl citrate or isopropyl myristate. A combination of diluents may be used, in equal or differing proportions. Triacetin, triethyl citrate and isopropyl myristate are particularly preferred.

There may be several factors influencing the stability and migration of diluents under ambient conditions. These factors may include hydrophobicity or hydrophilicity, viscosity, saturated vapour pressure at room temperature, boiling point, molecular structure (such as hydrogen bonding or Van der Waals forces) and the absorptive/adsorptive interaction between diluent and the substrate. Some diluents will suffer from migration problems to a greater extent than others; for instance, it has been found that triacetin, isopropyl myristate and triethyl citrate particularly benefit from encapsulation as in the present invention.

Another relevant factor is the loading level of the diluent in the smoking article. For instance, if a diluent such as glycerol is included in a large amount, migration problems can still be significant.

The barrier material is capable of inhibiting migration of the diluent during storage of the smoking article but allows release of the diluent during smoking of the smoking article. It may be one that melts, decomposes, reacts, degrades, swells or deforms to release the diluent at a temperature above room temperature but at or below the temperature reached inside a smoking article during smoking. For instance, the physical expansion occurring with vapourisation of sufficient levels of diluent may break down the structure of the barrier material. In embodiments of the invention, the barrier material releases substantial amounts of the diluent above 50° C., preferably above 60° C., 70° C., 80° C. or 90° C.

The barrier material may be, for example, a polysaccharide or cellulosic barrier material, a gelatin, a gum, a gel or a mixture thereof. Suitable polysaccharides include an alginate, dextran, maltodextrin, cyclodextrin and pectin. Suitable cellulosic materials include methyl cellulose, ethyl cellulose, hydroxyethyl cellulose, hydroxypropyl cellulose, carboxymethyl cellulose, and cellulose ethers. Suitable gums include gum Arabic, gum ghatti, gum tragacanth, Karaya, locust bean, acacia, guar, quince seed and xanthan gums. Suitable gels include agar, agarose, carrageenans, furoidan and furcellaran.

In a preferred embodiment of the invention, the barrier material comprises a polysaccharide. An alginate is especially preferred, due to its encapsulation properties. The alginate may be, for instance, a salt of alginic acid, an esterified alginate or glyceryl alginate. Salts of alginic acid include ammonium alginate, triethanolamine alginate, and group I or II metal ion alginates like sodium, potassium, calcium and magnesium alginate. Esterified alginates include propylene glycol alginate and glyceryl alginate.

In an embodiment, the barrier material is sodium alginate and/or calcium alginate. Calcium alginate provides a greater inhibition of migration of the diluent at ambient temperature than sodium alginate, but also may release the diluent at a higher temperature than the latter.

In another preferred embodiment, the barrier material comprises a gum and acacia gum is especially preferred. The gum may be the only barrier material used, or it may be combined with other barrier materials, such as crosslinked alginates.

In a yet further embodiment of the present invention, the diluent is encapsulated or embedded in a first barrier material, and this product is then coated by one or more layers of barrier material, which may be the same or different from the first barrier material. For example, in one embodiment, the diluent is encapsulated by a gum and then the encapsulated product is coated by one or more polysaccharide layers.

Encapsulation of the diluent with the barrier material is by any suitable method known to the skilled person or described herein. During the encapsulation process, the diluent is preferably employed in liquid form. In other words, diluents that are liquid at room temperature may be used without further processing, whereas diluents that are solid at room temperature may be melted, or incorporated into a liquid vehicle, i.e. a solution, suspension or emulsion. Preferably, the diluent is used in liquid form without any auxiliary liquid vehicle. However, if solid diluent particles are used, these may alternatively be coated directly with the barrier material.

In an embodiment, the encapsulated diluent particles are made by spray drying. This technique involves homogenizing a liquid comprising diluent and barrier material, and spraying into a hot gas. The process results in particles (1) consisting essentially of diluent (2) entrapped in a matrix of barrier material (3), as illustrated schematically in FIG. 1. An agglomeration and/or coalescence step can be applied to increase the particle size and decrease friability, if desired.

In another embodiment, a diluent having appropriate geometry and hydrophobicity is subjected to molecular encapsulation with β-cyclodextrin.

Alternatively, solid diluent particles or liquid droplets comprising the diluent may be dropped through a curtain of barrier material. In a further embodiment, diluent is co-extruded with the barrier material to form a capsule (10) made of a “shell” of the barrier material (3) surrounding a “core” of the diluent (2), as illustrated schematically in FIG. 2. In this process, liquid diluent and barrier material are fed through concentric orifices, the diluent being in the centre and the barrier material being in an outer annulus, to form a droplet which is then hardened by appropriate means, e.g. cooling, or crosslinking of the barrier material.

The particles of encapsulated diluent can contain any suitable amount of diluent. Preferably, however, the particles contain at least 10%, 20%, 30%, 40%, 50%, 60%, 70%, 80%, 90%, 95% or 99% diluent. Co-extrusion is advantageous, since this may allow the particles to have a higher diluent loading.

Importantly, whichever method is used, it should be noted that substantially no other material is encapsulated together with the diluent and any liquid vehicle for the latter. In particular, the encapsulated diluent particles contain substantially no tobacco, filler material or solid sorbent (such as chalk or carbon), or flavourant; the barrier material is in intimate contact with the diluent. However, certain impurities may be unavoidable. In addition, small amounts of colourant may be included; preferably this is not present homogeneously in the particles, but may, for example, be applied to the outer surface of the particles or mixed with the barrier material only. In an embodiment, the particles consist entirely of diluent encapsulated with barrier material.

The encapsulated diluent particles may be microparticles. Preferably, the average particle size is in the range 100 to 300 μm.

In an embodiment, individual encapsulated diluent particles of the same or different type are agglomerated together using a binder. Suitable binders will be known to the skilled person, such as the barrier materials described above. The agglomerations may be, for instance, 0.5-4 mm in size.

The aerosol generating material of the invention may consist entirely of encapsulated diluent particles (whether agglomerated or not), optionally of several different types. Alternatively, the encapsulated diluent particles may be combined with other substances and formulated into a new material in which the particles remain intact.

Such other materials may comprise a filler material e.g. ground chalk, a binder e.g. alginate, a plasticizer e.g. glycerol, and/or colourants as appropriate. For instance, the encapsulated diluent particles (1) may be combined with such materials to form a slurry that is cast and dried to form a sheet material (4), as illustrated schematically in FIG. 3. The use of up to around 15% glycerol by weight of the sheet, for example, may render the sheet suitably flexible. This glycerol may have the advantage of being transferred to the smoke along with the triacetin upon smoking, providing an additional diluent effect. Preferably, the sheet is then cut or shredded into pieces (5) to form the aerosol generating material (6) of the invention.

Preferably, the sheet is cut or shredded so as to have dimensions similar to those of cut tobacco. For instance, the sheet may be cut at 35-40 cuts per inch, preferably 36-39, 37 or 38 cuts per inch. The shredded portions may have a width of 0.5-2 mm and a length of 5 mm-5 cm. This has the advantage that the aerosol generating material may be processed using the same apparatus as cut tobacco. In addition, when the aerosol generating material is incorporated into the smokable filler material of the invention, the presence of the aerosol generating material is not readily apparent.

Alternatively, the slurry may be extruded to form lengths of material, which may then be cut into pieces, e.g. having the dimensions described above. Further, the aerosol generating material may be in the form of flakes.

The smokable filler material of the invention comprises smoking material and the aerosol generating material of the invention, preferably a blend of these substances. The smoking material may be tobacco, a tobacco-containing material or a non-tobacco-containing material such as a non-tobacco reconstituted material. Preferably, the smoking material is a tobacco-containing material, but more preferably the smoking material is tobacco.

The tobacco may be, for example, stem, lamina, dust or a mixture thereof. Suitable tobacco materials include the following tobacco types: Virginia or flue-cured tobacco, Burley tobacco, Oriental tobacco, or a blend of tobacco materials. The tobacco may be expanded, such as dry ice expanded tobacco (DIET), or processed by any other means such as extrusion.

Tobacco or other smoking materials can also or alternatively be incorporated in the sheet material described above.

In an embodiment, the aerosol generating material is provided with the smoking material as a simple mixture. In another embodiment, encapsulated diluent particles are agglomerated with or sprayed onto the smoking material using any suitable binder known to those skilled in the art. FIG. 4 schematically illustrates a tobacco particle (7) bearing encapsulated diluent particles (1).

Preferably, the smokable filler material of the invention contains at least 5% by weight diluent, preferably 10-30% by weight diluent. Preferably, the smokable filler material contains 5-95%, preferably 7-80%, 10-60%, 12-30% or 15-25% by weight of the encapsulated diluent particles.

The fourth aspect of the invention relates to a smoking article comprising the aerosol generating material of the invention. The aerosol generating material can be incorporated into the smoking article by conventional means. As used herein, the term “smoking article” includes smokeable products such as cigarettes, cigars and cigarillos whether based on tobacco, tobacco derivatives, reconstituted tobacco or tobacco substitutes. The term also includes so-called “heat-not-burn” products, which produce smoke or a smoke-like aerosol. The smoking article may be provided with a filter for the particulate and gaseous flow drawn by the smoker. Preferably, the smoking article is a cigarette.

The smoking article may contain a smokable filler material that consists of the aerosol generating material of the invention, i.e. no other smoking or aerosol generating material is incorporated into the smoking article. This may be particularly suitable for heat-not-burn smoking articles. Alternatively, the smoking article may contain the aerosol generating material as an additive.

FIG. 5 illustrates an embodiment of the invention in which the smoking article is a cigarette (8) that contains a filter (9) and a smoking rod (10). The aerosol generating material (6) is in shredded sheet form and is incorporated in the rod together with other components of the smokable filler material.

### EXAMPLE

12 kg Acacia gum was dissolved in 24 kg demineralised water. 4 kg triacetin was added to the mixture and homogenised in a high pressure homogeniser and fed to the feed tank of a spray drier. The mixture was spray dried and resulted in a fine powder with a bulk density of 390 g/L and an average laser particle size (D₅₀) of 53 μm. This powder was designated Product 1.

2 kg (on a dry weight basis) of the Product 1 powder was fluidised in a fluid bed drier and sprayed with 300 mL demineralised water to agglomerate the particles. The resulting agglomerate had a bulk density of 430 g/L and an average laser particle size (D₅₀) of 120 μm. This agglomerate was designated Product 2.

A further 2 kg of the Product 1 powder was coated with calcium alginate by first spraying the powder with a 6.6% sodium alginate solution in a fluid bed drier and subsequently spraying with a solution of calcium chloride to crosslink the alginate. The powder was also agglomerated in this process. The resulting particles had a bulk density of 380 g/L and an average laser particle size (D₅₀) of 610 μm. This material was designated Product 3.

1.8 kg of the Product 1 powder was blended with 100 g sodium alginate. This blend was sprayed with a 6.6% solution of sodium alginate in a fluid bed drier. The resulting material was then sprayed with a calcium chloride solution to crosslink the alginate. The resulting particles had a bulk density of 350 g/L and an average laser particle size (D₅₀) of 465 μm. This material was designated Product 4.

A further 2 kg batch of Product 3 was manufactured and coated with a second coating of calcium alginate by first spraying with a 6.6% sodium alginate solution in a fluid bed drier and subsequently spraying with a solution of calcium chloride to crosslink the alginate. The powder was also agglomerated in this process. The resulting particles were sieved into fractions of below 500 μm, between 500 and 1400 μm, between 1400 and 1500 μm, and above 2500 μm. The fraction over 2500 μm had a bulk density of 335 g/L. The fraction above 2500 μm was designated Product 5.

The five products are summarised in Table 1.

TABLE 1

| | | Bulk | Average | | Target | |
|---|---|---|---|---|---|---|
| Prod- | | den- | particle | Target | acacia | Target |
| uct | | sity | size (D₅₀) | triacetin | gum | alginate |
| No. | Description | (g/L) | (μm) | (%) | (%) | (%) |
| 1 | Spray dried | 390 | 53 | 25 | 75 | — |
| | powder | | | | | |
| 2 | Agglomerated | 430 | 120 | 25 | 75 | — |
| | Product 1 | | | | | |
| 3 | Product 1 with | 380 | 610 | 23.75 | 71.25 | 5 |
| | one coating of | | | | | |
| | calcium alginate | | | | | |
| | (agglomerated) | | | | | |
| 4 | Product 1 blended | 350 | 465 | 22.5 | 67.5 | 10 |
| | with sodium | | | | | |
| | alginate powder, | | | | | |
| | sprayed with | | | | | |
| | sodium alginate | | | | | |
| | solution and | | | | | |
| | finally treated | | | | | |
| | with calcium | | | | | |
| | chloride | | | | | |
| 5 | Product 3 with an | 335 | >2500 | 22.6 | 67.65 | 9.75 |
| | additional coating | | | | | |
| | of calcium | | | | | |
| | alginate | | | | | |
| | (agglomerated) | | | | | |

A sample of each product was placed in a shallow bed on a tray and stored at 22° C., 60% relative humidity. Further samples were placed in capped Schott bottles and also stored at 22° C., 60% relative humidity. The products were analysed for water and triacetin at the start of the experiment and again after 42 days storage on the trays and from the bottles. Results are shown in FIG. 6. The graph shows the triacetin content of the products with a 95% confidence interval.

These results show that the triacetin content of the products did not decrease over the 42 days of the storage trial. This indicates that the encapsulation of the diluent using these barrier materials was effective in preventing the migration or loss of the volatile diluent.

1. An aerosol generating material (6) for a smoking article, comprising particles (1) that consist essentially of diluent (2) encapsulated by barrier material (3).

2. An aerosol generating material (6) as claimed in claim 1, wherein the diluent (2) is a polyol aerosol generator or a non-polyol aerosol generator.

3. An aerosol generating material (6) as claimed in claim 1 or 2, wherein the diluent (2) is a liquid at room temperature.

4. An aerosol generating material (6) as claimed in claim 3, wherein the diluent (2) is triacetin, triethyl citrate, and/or isopropyl myristate.

5. An aerosol generating material (6) as claimed in any of the preceding claims, wherein the barrier material (3) comprises a polysaccharide, a gum, a cellulosic material, a gelatin, a gel or a mixture thereof.

6. An aerosol generating material (6) as claimed in claim 5, wherein the barrier material (3) comprises an alginate.

7. An aerosol generating material (6) as claimed in claim 5, wherein the barrier material (3) comprises acacia gum.

8. An aerosol generating material (6) as claimed in any of the preceding claims, wherein the particles (1) consist essentially of a shell of the barrier material (3) surrounding a core of the diluent (2).

9. An aerosol generating material (6) as claimed in any of the preceding claims, wherein the particles (1) contain substantially no tobacco, filler material, solid sorbent, or flavourant.

10. An aerosol generating material (6) as claimed in any of the preceding claims, wherein the particles (1) contain at least 10% diluent, preferably at least 50% diluent, preferably at least 90% diluent.

11. An aerosol generating material (6) as claimed in any of the preceding claims, further comprising filler material and binder material.

12. An aerosol generating material (6) as claimed in any of the preceding claims, which is a cut or shredded sheet material.

13. A smokable filler material, comprising smoking material and an aerosol generating material (6) as claimed in any of the preceding claims.

14. A smokable filler material as claimed in claim 13, containing at least 5% by weight diluent (2).

15. A smokable filler material as claimed in claim 13 or 14, wherein the encapsulated diluent particles are carried on the surface of tobacco particles.

16. A smoking article (8) comprising an aerosol generating material (6) as claimed in any of claims 1 to 12, or a smokable filler material as claimed in any of claims 13 to 15.

17. A method of producing an aerosol generating material (6) as claimed in any of claims 1 to 12, comprising encapsulating a substance in barrier material (3), wherein the substance consists essentially of diluent (2).
